(19) United States
(12) Patent Application Publication
(10) Pub. No.: US 2006/0197650 A1
(43) Pub. Date: Sep. 7, 2006

(54) Passive transmitter

(75) Inventors: Mark Jones, Long Beach, CA (US); Marshall Moore, Danville, CA (US); Sam Talpalatsky, San Diego, CA (US)

Correspondence Address: SAM TALPALATSKY, 10867 CLOVERHURST WAY, SAN DIEGO, CA, 92130, US

(73) Assignee: MAGNADYNE CORPORATION, COMPTON, CA (US)

(21) Appl. No.: 11/070,520

(22) Filed: Mar. 2, 2005

(51) Int. Cl. H04Q 1/00; G05B 19/00

(52) U.S. Cl. 340/5.61; 340/5.72; 340/5.64

(57) ABSTRACT

A remote control transmitter configured to operate with a vehicle controller. The transmitter is operable in an active mode and a passive mode. In the active mode the disarm/unlock command is sent by user activating a switch. In the passive mode the disarm/unlock command is automatically sent by the transmitter without the user having to activate any switches on the transmitter. The transmitter is configured to switch from the passive mode to the active mode in response to at least one of a user activated signal or a battery threshold signal.

### BACKGROUND

1. Field of the Invention

The present invention relates generally to vehicle security and convenience systems, employing a transmitter that automatically or passively activates some or all of the functions controllable by a vehicle mounted controller programmed to respond to such transmitters.

2. Discussion of the Prior Art

Vehicle security and convenience systems have evolved over time. One of the more significant contributions of these systems is the remote access to the vehicle and the ability to disable one or more of the normal vehicle operating functions, such as the ability to start the vehicle. By sending an arm signal from an authorized transmitter, the prior art systems are designed to lock the doors and prevent the vehicles from starting or operating. To achieye this functionality, the prior art security systems included a controller installed in a vehicle that is responsive to a remote control transmitter. The controller controls the operation of various functions such as lights, door locks, and security features such as the starter disable and ignition cutoff.

One of the drawbacks to the prior art systems is the requirement of actively controlling the controller by pressing switches on the transmitter, i.e. the active mode. As an example, active mode is undesirable when the user's hands are full. To address this need the industry introduced passive transmitters that automatically and periodically transmit unlock or disarm signal. Although effective, passive transmitters over time use more power and therefore exhaust the power source capacity, such as a battery, significantly faster than the conventional active transmitters. A transmitter with an exhausted power source creates an inconvenience at best, leaving the user stranded.

The power exhaustion problem was in part addressed by motion detectors. Such passive units would time out and not generate or send signals unless retriggered by motion, or they would operate only during motion. The downside to this solution was the unreliability of mechanical devices and continued use of power while the transmitter was carried about by the user.

### SUMMARY

The disclosed device is a passive transmitter that automatically switches to the active mode from passive mode when its power source reaches predetermined power threshold, such as 2.5 volts, in a 3.0 volt battery, as an example. In one embodiment a comparator senses the power capacity of the power source and when the power capacity reaches the threshold the comparator sends a signal that switches the transmitter from the passive to the active mode. It is understood, that various power sources may be applied and that in the present the most conventional power source is a battery. Other sources may be available over time.

In another embodiment, the disclosed device switches from passive to active mode, or vice versa, by the activation of one or more switches on the transmitter. In another embodiment, the transmitter will switch modes responsive to a sequence of switches or a sequence of switches within a predetermined amount of time. As an example, the transmitter will toggle between passive and active modes responsive to two activations of switch A within n-seconds followed by activation of switch B within another second. Such depressions are indicative of intentional control and allow the user to switch between modes

### BRIEF DESCRIPTION OF THE DRAWINGS

FIG. 1 illustrates a block diagram of the transmitter and the controller.

FIG. 2 illustrates a flow chart of one embodiment of the novel transmitter, where the transmitter will change states in response to receiving multiple activations of one or more switches within a predetermined amount of time.

FIG. 3 illustrates a flow chart of another embodiment of the novel transmitter, where the transmitter will change states in response to receiving multiple activations of a designated switch within a predetermined amount of time.

FIG. 4 illustrates a flow chart of another embodiment of the novel transmitter, where the transmitter will change states in response to receiving activations of at least two designated switch within a predetermined amount of time.

### DETAILED DESCRIPTION

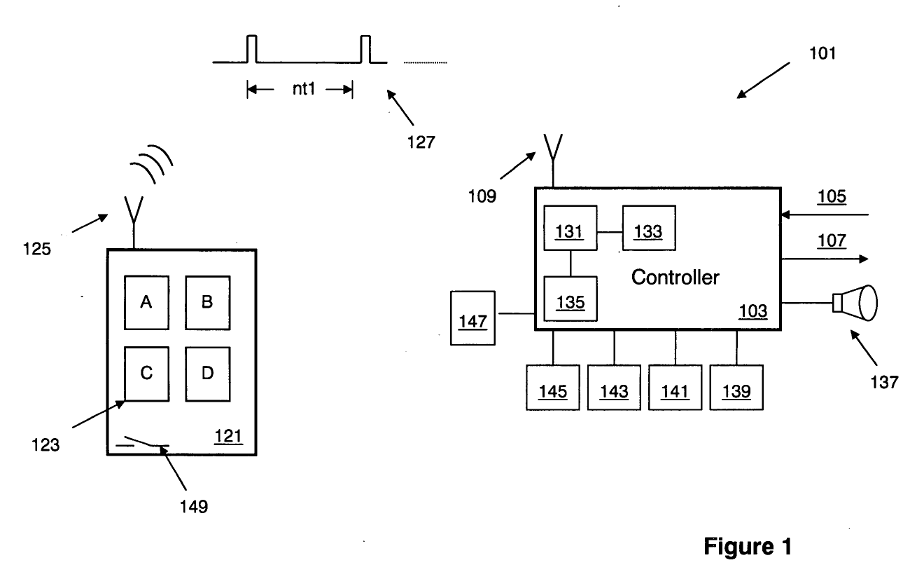

Shown in FIG. 1, is a representative security and/or vehicle convenience system (hereafter the “system”) 101. System 101 generally comprises one or more authorized transmitters 121 capable of transmitting command signals 127 to a controller 103. In response controller 103 executes commands received from such authorized transmitters 121 or commands programmed into its structure. The structure of controller 103 consists, but is not limited to a memory 133; a logic execution device 131, such as a microprocessor; a decoder 135; one or more on-board and/or off-board relays 139; an on-board and/or off-board visual indicator 141, such as a light emitting diode; an antenna 109; an override switch 143, commonly referred to as a valet switch; and an acoustical transducer such as a siren 137. It is foreseeable that some or all of these components may be integrated into a single functioning unit, by consolidating discrete circuitry into one or more ICs (integrated circuits).

The command signal 127 generally comprises an authorization code, which is initially programmed into controller 103. This provides access to and control of controller 103 via one or more authorized transmitters 121. Also part of the command signal 127 is a command code. The command code communicates to controller 103 the function that the authorized user wants executed. Examples of such functions, among others, are electrical signals via control lines or bus 107 to lock doors, to unlock doors, to flash lights, to open the trunk, lower or raise windows, and to sound siren 137. The commands are initiated by a user activating one or more switches 123 of authorized transmitter 121. Typically, command signal 127 is received by an antenna 109, decoded by a decoder 135 and the resulting digital string of signal 127 is then,passed on to processor or logic and/or software 131 (hereafter collectively “logic circuitry 131”). Logic circuitry 131 then checks if the authorization code of command signal 127 matches a previously programmed authorization code normally resident in a memory 133. If the received and stored authorized codes match, then controller 133 executes the command code of signal 127.

Outputs 107 control various functions in response to commands received from transmitter 121 or in response to conditions programmed into controller 103. Some of the exemplary functions are: 1) signal to lock and unlock the doors of a vehicle, either in response to transmitter 121 or automatically (passive arming) after a period of time; 2) flashing of lights, such as parking lights to provide a visual indication of executing a function; 3) audio feedback, such as the beeping of horn 137 or some other audio transducer 137 to provide an audio indication of executing a function; 4) starting of the vehicle; 5) controlling the trunk of the vehicle; 6) raising or lowering windows of the vehicle; 5) operational interrupt or cutoff via a relay 139, disabling a starting circuit or ignition circuit of the vehicle; and 6) any other function of the vehicle.

Input 105 provide controller 103 and its processor or logic unit 131 with control signals or conditional indication of one or more sensors 145 and/or 147 are placed about the vehicle. One example is a shock sensor 145 (shown as a dedicated input), indicating a shock or a physical disturbance in or about the vehicle. Shock sensor 145 and other sensors 147 or inputs could have either a dedicated input as diagrammatically shown in FIG. 1, or they can be electrically coupled to a data bus, providing digital or analog indication that the sensor was triggered. Another example of sensor 147 is a pin switch indicating that one or more of the doors are open. Yet another example is a signal from an infrared signal or magnetic field sensor. Visual indicator 141 is common place in security systems, providing a visual indication of the controller's status. As one example, the indicator 141 could be a light emitting diode, flashing at a 50% duty cycle, indicating that the system is armed. Such indicators 141 are commonly placed in a conspicuous place on or about the dash of the vehicle to warn away the potential intruders.

Also a part of a typical system 101 is override switch 143, commonly referred to as a “valet” switch. Switch 143 is inconspicuously mounted by the installer in the vehicle and its location is provided to the authorized user. Switch 143 has a number of functions, one of which is to disarm controller 103. In other applications it is used to program controller 103.

Although relay 139, visual indicator 141, override switch 143, sensor(s) 147, and shock sensor 145 are illustrated having dedicated input to controller 103, these units and other units coupled to controller 103 could be coupled through a bus now employed in a number of vehicles. This bus has a predetermined protocol and it allows the vehicle manufacturer to apply a number of electrical units without having to install dedicated harnesses to control them. This is a cost, power and weight savings, as well as a way to reduce a number of parts, thus increasing the reliability.

Having described a typical security and vehicle convenience system 101, attention is drawn to a passive arming functionality. By way of review, passive arming refers to controller 103 that automatically arms within a specified time after ignition is turned off, which is illustratively sensed by controller 103 through input 105.

Yet in other systems, the automatic arming occurs after the ignition is turned off and a pin switch 147 changes from a first state to a second state and back to the first state, indicating that the user turned off the vehicle, opened the door and closed it.

Also by way of review, typical passive transmitters send unlock signals 127 to controller 103 without the user pressing one or more switches 123. Some transmitters automatically send such signals 127 every n-seconds (the period defined by the user or the manufacturer). Therefore, as the user approaches the vehicle and controller 103, once in range, controller 103 receives the automatically generated and transmitted signal 127 and the vehicle is unlocked by the time the user reaches the vehicle. Yet other systems recognized that such passive transmitters use more battery power than active transmitters that only send the signal when activated via switches 123. To resolve the power drain concerns, such transmitters gate the signal 127 with motion detection, either electronic or mechanical. Thus, the periodic signal is sent only when the on-board sensor detects some movement of the transmitter. Such transmitters do provide a level of power conservation, but on average they continue to use more battery power reserves because the transmitter continues to send signal 127 when the transmitter is in motion. In such transmitters, the battery reserves are eventually exhausted and the rate of power exhaustion is greater than the rate of power exhaustion of an active transmitter.

Disclosed in system 101, is a transmitter 121 that automatically turns off the passive arming functionality when its power source, such as a battery, reaches some defined capacity threshold. Thus, regardless of whether the transmitter is gated with a motion sensor or is continuously in passive mode, once the battery or its power reserves reach some predetermined level, the passive functionality will revert to active functionality. When the user senses that the system 101 no longer unlocks the doors and/or disarms controller 103 automatically/passively, it is an indication that the battery in transmitter 121 should be changed. Moreover, the user still has full control of system 101.

Also disclosed is transmitter 121 that can be changed by user from the passive mode to the active mode and vice versa. This allows the user, in addition to the power level protection described above, to change the modes at will. Some users will simply prefer the active mode over the passive mode. Others will place transmitter 121 in active mode because they prefer to leave transmitter 121 or spare transmitter 121 in the vehicle or within the signal range of transmitter 121 and controller 103. The user can therefore selectively switch the described transmitter 121 from one state to the other by a switch 149 resident on transmitter 121. In one embodiment of transmitter 121, with switch 149 in its open state, transmitter 121 will be in the active mode when switch 149 is open and in the passive mode when switch 149 is closed, or vice versa.

In some situations it is desirable to eliminate switch 149 from the build of materials and maximize the functionality of the existing controls already resident on transmitter 121, such as switches 123. Therefore, in an alternate embodiment the described device could allow the user to select between the active and passive modes by a series of switch 123 controls within a period of time. As one example, the user could toggle between the passive and active modes of transmitter 121 by depressing switch D 123 of transmitter 121 in quick succession, at least twice, within n seconds, where n is any number of or fraction of seconds.

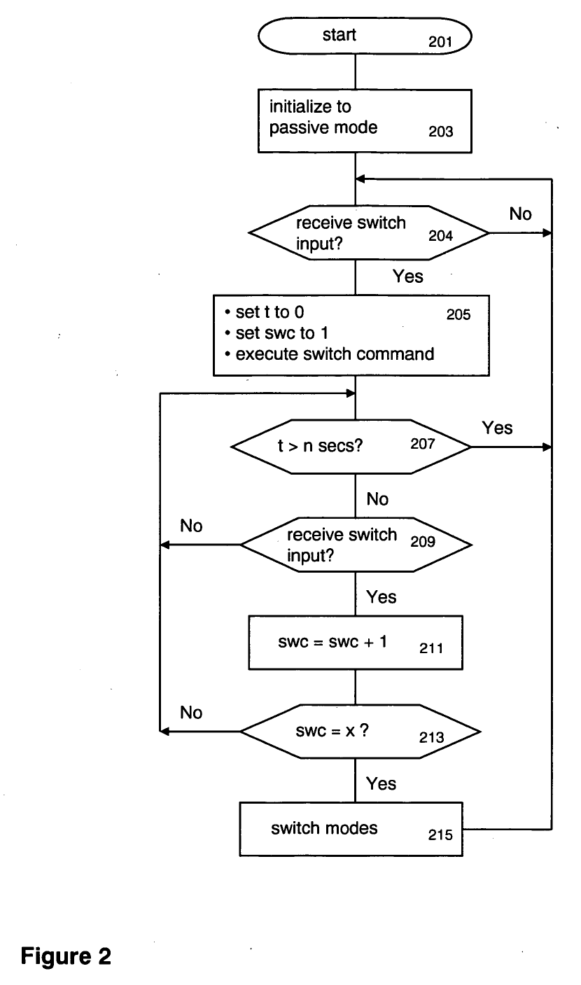

FIG. 2 is a flowchart of an embodiment, allowing the user to toggle between passive and active arming states of transmitter 121. Resident in transmitter 121 is logic circuitry and/or processing/software logic (the “logic circuitry”) 131 that begins at 201 and then initializes the transmitter to one of the modes at 203. By way of example, logic circuitry 131 initializes transmitter 121 to the passive mode. Note that in this embodiment and others described herein, transmitter 121 could have initialized to active mode as well without affecting the intent and the scope of the invention. At 204 logic circuitry 131 loops waiting for the activation of switches 123. Once one of switches 123 is activated, at 205 the logic circuitry sets time counter t to 0 seconds and counter swc to 1 and executes the command associated with the activation of switch 123. Next, at 207 the logic circuitry checks if the time to period to successively press switch 123 exceeds the allowable time of n seconds. If the allowable time is exceeded, logic circuitry 131 returns to 204 and waits for the next activation of switch 121. Once the next activation of switch 123 is received at 204, at 205 the logic circuitry resets the time t to 0 and switch counter swc to 1. However, if at 207 the time parameter is not reached, logic circuitry 131 checks if switch 123 has been activated by the user again. If so, switch counter swc is incremented at 211. If not, logic circuitry loops from 209 to 207 for the time duration of n seconds or less, anticipating the activation of switch 123. As explained above, at 211 the logic circuitry increments the switch counter swc when switch 123 is activated within the n second window. At 213, the logic circuitry checks if the right number of activations of switch 123 took place. If so, at 215, logic circuitry 131 toggles modes and returns to 204, where the next switch input is monitored. If the right number of switch activations did not take place, logic circuitry 131 loops back to 207 until the time from the initial activation of switch 123 has exceeded n seconds at 207.

Additionally, in this embodiment and others, optionally some type of feedback indication could be provided to the user, confirming that the modes were successfully changed from one to the other. Such indications could be visual or audible, depending on the transmitter. Also note that for exemplary, but not limiting reasons, the description of the embodiment of the flowchart in FIG. 2, and others herein, was not limited to a specific switch 123. Therefore any succession of switches 123 would achieve the desired result of toggling between the successive modes of transmitter 121. Similarly, it is contemplated that the most versatile implementation of logic circuitry 131 is to employ a microprocessor. However, this is a discretionary choice that is not intended to limit the scope of the present invention. In the same tone, the time parameter n and activation count x are a discretionary implementation choice and are not intended alone or in combination to limit the invention. These parameters could be set by the manufacturer or in another embodiment defined at the time of installation via a communication device (not shown) coupled to transmitter 121, or defined by the user via control devices (such as switches 123, 147, and/or 149). In sum, the flowchart of FIG. 2, shows one embodiment that allows the user to toggle between one or more modes of transmitter 121 using x successive activations of control switch(es) 123 within n seconds.

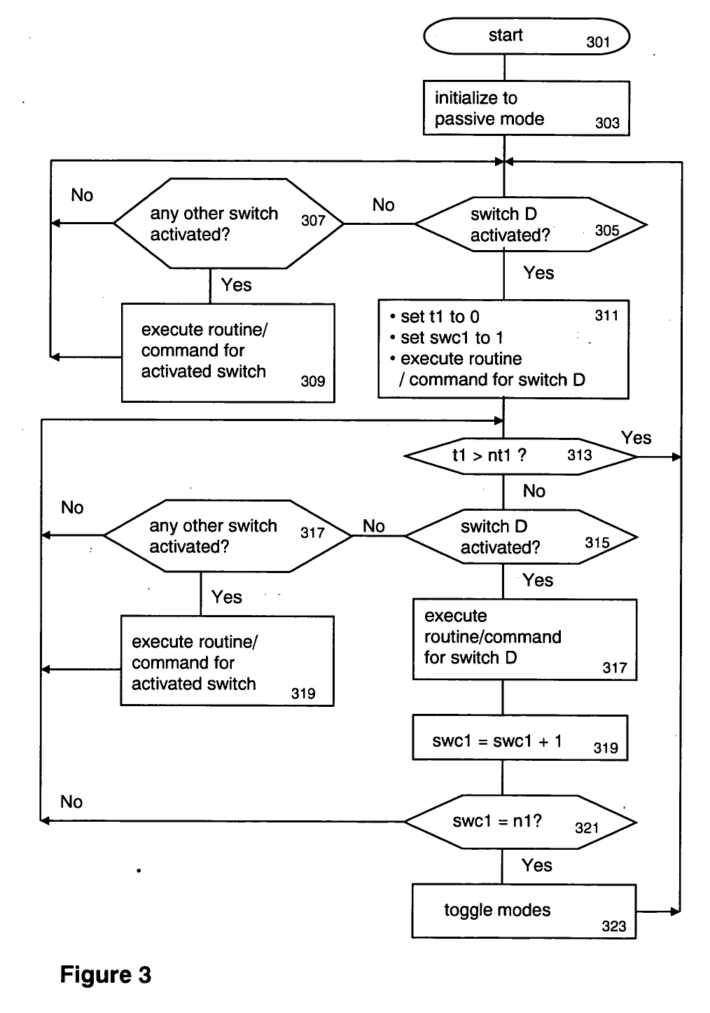

FIG. 3 is a flowchart of a variant embodiment, where one of switches 123 is designated to toggle modes resident in transmitter 121 and where transmitter 121 will continue to recognize and execute commands activated by one or more other switches 123 in between successive activations of such designated switch 123. This embodiment addresses and avoids unintended toggling of modes. To achieve this objective, it is generally advantageous to decrease the time parameter nt1 to prevent the user from unintentionally switching modes by pressing switch 123 in unintended succession. On the other hand, as the time parameter nt1 decreases, it is more challenging for some users to activate switch 123′ within that time a number of times in succession. Overall, it is up to the manufacturer or user to define the time period nt1. However, in those instances where it is possible to activate one or more non-designated switches 123 as well as the designated switches 123 within the time period nt1, it is desirable to execute the command representative of such non-designated switches 123. As an example of the embodiment of FIG. 3, it is possible for the user to activate switch 123 A in between two successive activations of switch 123 D, within the exemplary two second period of time representing nt1. In the scenario where transmitter 121 is programmed to toggle its modes when it receives two depressions of switch 123 D within two seconds, the embodiment of FIG. 3 will execute such toggle and it will respond to the command corresponding to the activation of switch 123 A, which in typical systems 101 is the unlocking of the vehicle doors and/or disarming of controller 103.

Described in more detail, flowchart of FIG. 3 starts at 301 and then initializes transmitter 121 to the passive mode. Note that transmitter 121 could have initialized to active mode as well without affecting the intent and the scope of the invention. Then logic circuitry 131 monitors the activation of the designated switch D 123 at 305. At 307 the logic circuitry monitors for activation of another switch 123 and if the user activates it, it will execute the command associated with that activation at 309 and then loop back to 305. If another switch is not activated at 307, logic circuitry 131 will loop back to 305. Therefore, until the first activation of designated switch D 123, logic circuitry 131 will loop from 305 through 307 and back to 305. Or, if another switch 123 is activated, logic circuitry 131 will loop from 305 to 307 to 309 and then revert to 305. If the designated switch D 123 is activated at 305, logic circuitry 131 advances to 311, where it will set the time counter t1 to 0, set switch counter swc1 to 1, and execute the command associated with switch D 123. Once at 313, logic circuitry 131 monitors if the time counter t1 exceeds its threshold defined by nt1. If the time threshold is exceeded, that indicates that two or more successive activations of designated switch D 123 did not take place in the allowable time and logic circuitry 131will revert to 305. If at 313 the time threshold defined by nt1 is not exceeded, logic circuitry 131 will continue to monitor for the subsequent activation of switch D 123 at 315. If switch D 123 is not activated, logic circuitry 131 will also monitor any other switch 123 activations at 317. If such activations are not received, logic circuitry 131 will loop back to 313 from 317. If at 317 additional switch 123 is activated, logic circuitry 131 will execute the command associated with such switch 123 at 319 and then loop back to 313 continuing to monitor the time counter t1 since first activation of designated switch D 123. If another activation of designated switch D 123 is detected at 315, the logic circuitry executes the command associated with switch D 123 at 317 and then proceeds to increment the switch count swc1, at 319. Counter swc1 is then compared to the programmed number of activations represented by n1, at 319. If swc1 is not equal to such programmed number of activations, the logic circuitry loops back to 313. If swc1 is equal to n1, then logic circuitry 131 toggles the modes at 323 and loops back to 305.

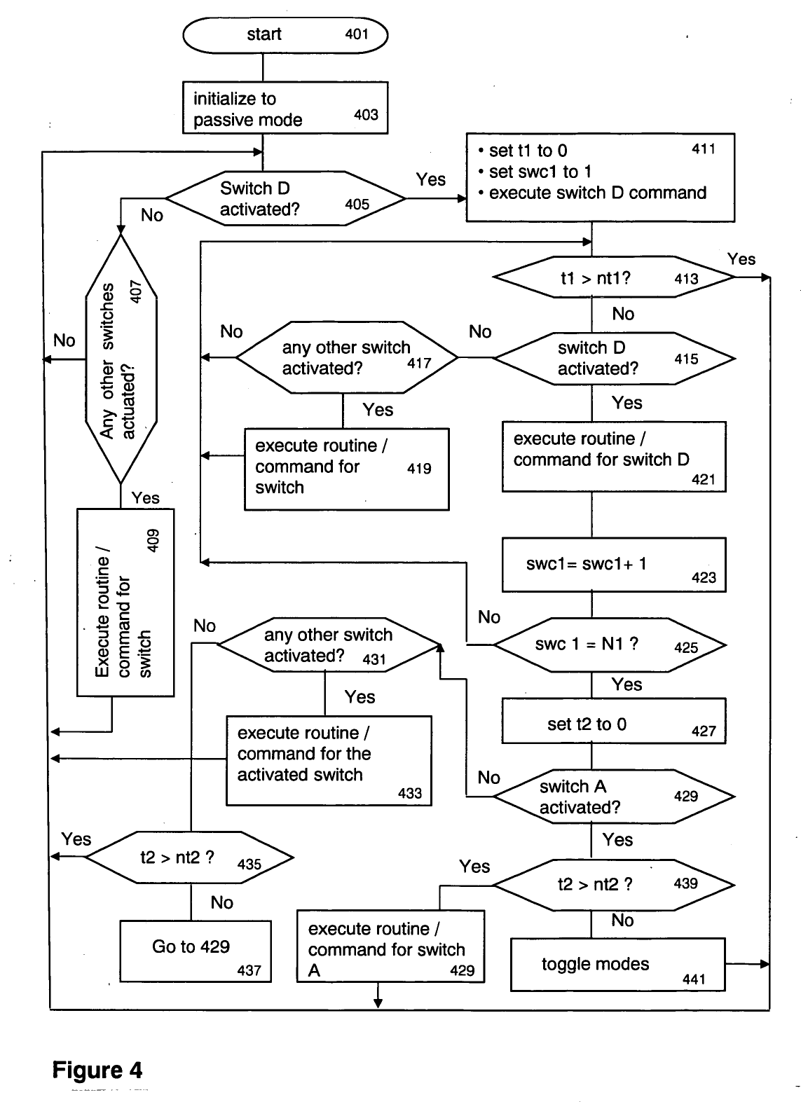

FIG. 4 is a flowchart of an alternate embodiment that allows transmitter 121 to toggle modes in response to receiving successive activations of two designated switches 123. As an example, it may be desirable to safeguard against inadvertent toggle of modes by switching modes in response to successive activations of a first designated switch 123 within a time nt1, followed by one or more activations of a second designated switch 123 within a time nt2. By way of example, to switch modes, the user would activate switch D 123 twice within a second, followed by activating switch C 123 twice within 1 second of the last activation of switch D 123. Overall, the more complicated the sequence and time process, the less likely it is that the modes are switched inadvertently. It is understood however, that in this and other described embodiments, the combination of activations, the timing, the number of successive activations are can be defined without departing from the intent and the scope of the invention.

Described in more detail, flowchart of FIG. 4 starts at 401 and then initializes transmitter 121 to the passive mode. Note that transmitter 121 could have initialized to active mode as well without affecting the intent and the scope of the invention. Then logic circuitry 131 monitors the activation of designated switch D 123 at 405. If switch D 123 is not activated, logic circuitry 131 monitors for the activation of another switch 123 at 407. If another switch 123 is not activated, the logic circuitry loops back to 405. If, however, another switch 123 is activated at 407, then the command associated with that switch 123 is executed at 409 and logic circuitry 131 loops back to 405. When switch D 123 is activated at 405, at 411 timer t1 is set or reset to 0, counter swc1 is set to 1 (reflecting the activation of switch D 123 at 405), and the command associated with switch D 123 is executed. Then decision is made at 413 of whether or not timer t1 is greater than the allowed time to activate switch D 123 its predetermined number of consecutive times, N1. In the first pass timer t1 is less than the time threshold nt1. Therefore, at 415 switch D 123 is monitored for activation. If it is not activated at 415, other switch activations are monitored at 417. If no other switches 123 are activated, logic circuitry 131 loops back to 413. If another switch 123 is activated, its associated command is executed at 419 and then logic circuitry 131 loops back to 413. If the time for consecutive switch D 123 activations expired, as detected at 413, logic circuitry 131 loops back to 405 and monitors for subsequent activations of switch D 123. If however, the time has not yet expired at 413 and another activation of switch D 123 is detected at 415, its assigned command is executed at 421, counter swc1 is incremented at 423 and at 425 the counter swc1 is compared to the programmed number of consecutive activations required to change the mode, N1. If the required number N1 is not yet reached, logic circuitry loops back to 413. If it is reached, then a second timer t2 is set or reset to 0 at 427. Now at 429 the logic circuitry is monitoring a timed operation of the second designated switch 123, which is for exemplary purposes, is switch A 123. The logic circuitry then checks if designated switch A 123 is activated, at 429. If it is not, it checks if any other switch 123 is activated at 431. If a non-designated switch 123 is not activated, timing threshold t2 to receive the second designated switch A 123 is then checked at 435. If at 435 the timer t2 exceeds the threshold nt2, then the logic circuitry loops back to 405, i.e. the conditions for changing the mode were not satisfied. If however, the time for receiving the second designated switch activation of switch A 123 has not yet run at 435, the logic circuitry loops back to 429, where it continues to monitor for activation of switch A 123. At 431, if another switch 123 is activated, its command is then executed at 433 and logic circuitry 131 returns to 405 without changing the modes. This is so because in this embodiment activation of the second designated switch A 123 is a requirement for changing the modes of transmitter 121. However, one of ordinary skill in the art could readily modify or combine the embodiments of flowcharts in FIGS. 2-4 to accept and execute the command of the activated switch 123 and continue monitoring for designated switch A 123 within the time threshold of nt2. If switch A 123 is activated at 429, at 439 timer t2 is checked against the timing threshold nt2. If the second designated switch A 123 at 429 was received within the timing requirement of nt2 (again as checked at 439) then, mode is toggled at 441 and the logic circuitry is looped back to 405. If however the activation of switch A 123 is received outside the timing parameter of nt2, logic circuitry 131 executes the command of switch A 123 and then loops back to 405.

By reading this specification, various other combinations of switch 123 activations, including the number of activations and time parameters will be apparent to one of ordinary skill in the art. While the present invention has been described herein with reference to particular embodiments thereof, a degree of latitude or modification, various changes and substitutions are intended in the foregoing disclosure. It will be appreciated that in some instances some features of the invention will be employed without corresponding use of other features without departing from the spirit and scope of the invention as set forth.

We claim:

1. A remote control transmitter configured to control a vehicle controller, wherein said controller is operable to control at least one of vehicle security and vehicle convenience features, said transmitter comprising:
a memory storing at least one authorization code and at least one command code;
an active mode wherein an encoder, coupled to said memory and in response to a user activating at least one switch resident to said transmitter, is operable to encode and transmit at least one of said authorization code and said command code;
a passive mode wherein said encoder is coupled to said memory and is configured for periodic encoding and transmission of said at least one of said authorization code and said command code from said transmitter without the user activating said at least one switch of said transmitter; and
said transmitter configured to switch to said active mode from said passive mode in response to at least one of a user activated signal or a power source capacity threshold.

2. The transmitter of claim 1 wherein said user activated signal comprises at least one activation of said at least one said switch.

3. The transmitter of claim 1 wherein said user activated signal comprises at least one activation of said at least one said switch within a predetermined period of time.

4. The transmitter of claim 1 wherein said user activated signal comprises said activation of two or more of said switches in a predetermined sequence.

5. The transmitter of claim 1 wherein said user activated signal comprises said activation of two or more of said switches in a predetermined sequence and in a predetermined period of time.

6. The transmitter of claim 1 wherein said power source capacity threshold comprises a signal indicating that a power source is at or below a predetermined voltage level.

7. The transmitter of claim 6 wherein said power source is a battery.

8. A remote control transmitter means operable to control a vehicle controller means for controlling at least one of vehicle security and vehicle convenience features, said transmitter means comprising:
a memory means for storing at least one authorization code and at least one command code;
an active mode wherein an encoder means is coupled to said memory means and in response to a user activating at least one switch means resident to said transmitter means, said encoder means is configured for encoding and transmitting at least one of said authorization code and said command code;
a passive mode means wherein said encoder means is configured for periodic encoding and transmission of said at least one of said authorization code and said command code from said transmitter means without the user activating said at least one switch; and,
said transmitter means configured to switch to said active mode from said passive mode in response to at least one of a user activated signal or a power source capacity threshold.

9. The transmitter means of claim 8 wherein said user activated signal comprises at least one activation of said at least one said switch.

10. The transmitter means of claim 8 wherein said user activated signal comprises at least one activation of said at least one said switch means within a predetermined period of time.

11. The transmitter means of claim 8 wherein said user activated signal comprises said activation of two or more of said switch means in a predetermined sequence.

12. The transmitter means of claim 8 wherein said user activated signal comprises said activation of two or more of said switch means in a predetermined sequence and in a predetermined period of time.

13. The transmitter means of claim 8 wherein said power source capacity threshold comprises a signal indicating that a power source means of said transmitter means is at or below a predetermined voltage level.

14. The transmitter of claim 13 wherein said power source means is a battery.

15. A method of switching operating modes of a remote control transmitter operable to control a vehicle controller, wherein said controller controls at least one of vehicle security and vehicle convenience features, said method comprising:
accessing at least one authorization code and at least one command code stored in a memory;
operating in an active mode and encoding and transmitting at least one of said authorization code and said command code in response to a user activating at least one switch of said transmitter;
operating in a passive mode and periodically encoding and transmitting at least one of said authorization code and said command code without the user activating said at least one switch; and,
switching to said active mode from said passive mode in response to at least one of a user activated signal or a power source capacity threshold.

16. The method of claim 15 wherein said user activated signal comprises at least one activation of said at least one said switch.

17. The method of claim 15 wherein said user activated signal comprises at least one activation of said at least one said switch within a predetermined period of time.

18. The method of claim 15 wherein said user activated signal comprises said activation of two or more of said switches in a predetermined sequence.

19. The method of claim 15 wherein said user activated signal comprises said activation of two or more of said switches in a predetermined sequence and in a predetermined period of time.

20. The method of claim 15 wherein said power source capacity threshold comprises a signal indicating that a power source is at or below a predetermined voltage level.

21. The method of claim 20 wherein said power source is a battery.
